(19) United States
(12) Patent Application Publication
(10) Pub. No.: US 2002/0187269 A1
(43) Pub. Date: Dec. 12, 2002

(54) Method of applying treatment chemicals to fiber-based planer products and products made using same

(75) Inventors: Andrea Urban, Ludwigshafen (DE); Walter Hill, Lampertheim (DE); Stephan Eichhorn, Gernsheim (DE); Heiko Steuer, Gustavsburg (DE)

Correspondence Address: YOUNG & THOMPSON, 745 SOUTH 23RD STREET 2ND FLOOR, ARLINGTON, VA, 22202

(73) Assignee: SCA HYGIENE PRODUCTS GMBH, MANNHEIM (DE)

(21) Appl. No.: 10/183,569

(22) Filed: Jun. 28, 2002

Related U.S. Application Data
(63) Continuation of application No. PCT/EP00/12901, filed on Dec. 18, 2000.

(30) Foreign Application Priority Data
Dec. 30, 1999 (DE) 199 63 826.8

(51) Int. Cl. B05D 3/02

(52) U.S. Cl. 427/372.2

(57) ABSTRACT

A method of applying a treatment composition containing at least one treatment chemical to a fiber-based planar product. The method includes the steps of: a) applying the treatment composition to one side of the planar product, and b) allowing the treatment composition to penetrate the planar product at least in part. The treatment composition is heated before and/or during step b). The penetration of the treatment composition is preferably promoted by applying a subatmospheric pressure at that side of the planar product not treated with the treatment composition. A device usable for this method and a planar fiber-based product, in particular tissue is obtained.

### SPECIFICATION

The present invention relates to a method of applying treatment chemicals to fiber-based planar products, particularly tissue. It also relates to a device for performing the method and to the products, particularly tissue products, made using same. Within the framework of the present invention, the term “tissue” especially includes “tissue paper” or “raw tissue”, as is normally produced as a one-ply tissue web in the tissue (paper) machine, as well as including multiply (intermediate) products, e.g. in the form of multiply doubled webs or in the form of master rolls for further processing and ready-made one-ply and multiply tissue products such as paper handkerchiefs, facials, toilet paper, household towels such as kitchen towels, hand towels and other wipes etc.

### PRIOR ART

Based on the underlying correspondence of the production processes (wet laying), “tissue” production is counted among the paper making techniques. The production of tissue, or more accurately, raw tissue if the one-ply (intermediate) product manufactured on a special-purpose paper machine of the tissue or tissue paper machine is meant, is delimited from paper production as a result of the extremely low basis weight of normally less than 40 g/m² and as a result of the much higher tensile energy absorption index as compared to paper. The tensile energy absorption index is arrived at by relating the tensile energy absorption to the test sample volume before inspection (length, width, thickness of sample between the clamps before tensile load).

Paper and tissue paper also differ in general with regard to the modulus of elasticity that characterizes the stress-strain properties of these planar products as a material parameter, depending on the production conditions, raw materials used and chemical additives.

A tissue paper's high tensile energy absorption index results from the outer and/or inner creping. The former is produced by compression of the tissue paper web adhering to a dry cylinder as a result of the action of a crepe doctor or in the latter instance as a result of a difference in speed between two successive screens or e.g. between a sheet-forming screen and a so-called fabric or between two fabrics.

When applying the through air drying (TAD) technique for the production of raw tissue and the usual double-screen sheet formation in c-wrap configuration, for example, the so-called inner sheet-forming screen can thus be operated at a speed that is up to 40% faster than that of the next fabric or that of the subsequent felt, the initially formed and already pre-drained paper web being transferred to the next TAD fabric. This causes the still moist and as a result plastically deformable paper web to be internally broken up by compression and shearing, thereby rendering it more stretchable under load than a paper that has undergone neither “internal” nor external creping.

This transfer of a still plastically deformable paper web at a differential speed that simultaneously takes effect may also be brought about in other embodiments between a transfer fabric and the so-called TAD imprinting fabric or between two transfer fabrics.

German has adopted the English-language term “fabric” to designate paper machine covers that exhibit a screen-like fabric structure in which synthetic threads are used as a thread material instead of metal wires.

Most of the functional properties typical of tissue and tissue products result from the high tensile energy absorption index (see German standards DIN EN 12625-4 and DIN EN 12625-5). An example is represented by tissue products for hygienic applications (hygiene products, particularly hygiene paper products) which are e.g. used in personal grooming and hygiene, the household sector, industry, the institutional field in a very wide variety of cleaning processes. They are used to absorb fluids, for decorative purposes, for packaging or even just as supporting material, as is common for example in medical practices or in hospitals. In terms of their wide variety, hygiene products are now considered to be everyday products.

Hygiene paper primarily includes all kinds of dry-creped tissue paper, as well as wet-creped paper.

The one-ply intermediate products originating from the paper machine and made of lightweight, i.e. low basis weight paper usually dry-creped on a yankee cylinder by means of a crepe doctor are generally described as “tissue paper” or more accurately raw tissue paper. The one-ply raw tissue may be built up of one or a plurality of layers respectively.

All one-ply or multiply final products made of raw tissue and tailored to the end user's needs, i.e. fabricated with a wide variety of requirements in mind, are known as “tissue products”.

Typical properties of tissue paper include the ready ability to absorb tensile stress energy, their drapability, good textile-like flexibility, properties which are frequently referred to as bulk (crumple) softness, a high-surface softness, a high specific volume with a perceptible thickness, as high a liquid absorbency as possible and, depending on the application, a suitable wet and dry strength as well as an interesting visual appearance of the outer product surface. These properties allow tissue paper to be processed into tissue products (tissue paper products) and are then available to end users in a wide variety of forms and fabrication, for example as wipes, towels, household towels, particularly as kitchen towels, sanitary products (e.g. toilet paper), paper handkerchiefs, cosmetic tissues (facials) or serviettes/napkins.

Depending on the particular application, varied and to an extent conflicting properties are frequently needed for the successful use of tissue products in their extremely broad range of applications.

For this purpose, the tissue is frequently provided with substances, additives, auxiliary substances and other treatment chemicals.

In accordance with the invention, this term will also cover any substance or blends of substances generally referred to as treatment chemicals and normally applied to the tissue after the drying and creping step on the yankee cylinder.

Treatment chemicals may have an influence on physical properties, e.g. softness, particularly bulk softness, strength in the dry and wet states, rate of absorption of liquids, particularly that of water or oil, or the structural strength of the tissue/tissue product itself, and/or they may contribute to their varying use, e.g. in the field of skin care and protection, healthcare, etc. “Lotions” are also particularly referred to in the latter case.

Household towels for example, particularly kitchen towels and to an even greater extent paper towels, require strength, especially in the wet state, and high suction capacity so as to satisfy consumer demands. In the case of toilet paper, a combination of dry strength plus good softness is more likely to determine suitability in practice and acceptance among consumers. In the case of other tissue products such as handkerchiefs or facial wipes, surface softness and excellent suppleness are predominant properties which, in addition to strength, define the serviceability of these products.

Cosmetic components contained in the product, particularly on its outer surfaces, also play an important part in the latter tissue products. Such cosmetic components include, inter alia, perfumes, moisturizers, skin care agents, healthcare substances such as D-panthenol or the active camomile ingredient α-bisabolol.

It is important in the case of cosmetic components to achieve an optimum transfer of the components such as care agents or moisturizers from the tissue product to the skin—optimum in the sense of an adequate quantity of such components—so as to promote the desired effect. High amounts of the cosmetic substances to be applied to the tissue are necessary for this purpose. On the other hand, the tissue itself must not feel unpleasant or e.g. leave behind a wet feeling on the skin.

Manufacturers of tissue products are therefore especially faced with the challenge of achieving a particular balance between the various, frequently contradictory parameters in order to use this balance to obtain the optimum combinations of features required by consumers for the desired final products. The article entitled “Weichheit und Weichmachung von Hygiene-Tissue” in the Wochenblatt für Papierfabrikation, No. 11/12, 1988, pages 435 et seq., describes in detail the properties of hygiene tissue and discusses their importance to tissue products in different applications.

Thus, one of the principal market demands to be met by manufacturers is a general improvement in softness across all areas of tissue products. Properties such as the softness of a tissue product are defined in terms of their basic design by the production process, particularly by preliminary TAD and the choice of raw and auxiliary materials.

Softness is an important property of tissue products such as handkerchiefs, cosmetic wipes, toilet paper, serviettes/napkins, not to mention hand or kitchen towels, and it describes a characteristic tactile sensation caused by the tissue product upon contact with the skin.

Although the term “softness” is generally comprehensible, it is extremely difficult to define because there is no physical method of determination and consequently no recognized industrial standard for the classification of different degrees of softness.

To be able to detect softness at least semi-quantitatively, softness is determined in practice by means of a subjective method. To do so, use is made of a “panel test” in which several trained test persons give a comparative opinion.

In simplified terms, softness can be subdivided into its main characteristics, surface softness and bulk softness.

Surface softness describes the feeling perceived when e.g. one's fingertips move lightly over the surface of the sheet of tissue. Bulk softness is defined as the sensory impression of the resistance to mechanical deformation that is produced by a tissue or tissue product manually deformed by crumpling or folding and/or by compression during the process of deformation.

The application of the aforementioned treatment chemicals with which e.g. the desired softness characteristics or other properties are to be achieved is brought about in the prior art by different roll and spray application techniques. Other methods include impregnation techniques.

WO 94/05857 describes a method of applying a chemical paper-making additive to a dry tissue paper mat (tissue paper nonwoven fabric, raw tissue). The application technique is characterized by the following steps: provision of a dry tissue paper mat, dilution of a chemical paper-making additive using a suitable solvent to form a diluted chemical solution, the application of this diluted chemical solution to a heated transfer surface, partial evaporation of the solvent through the transfer surface to form a film that contains this paper-making additive and the transfer of this film from the heated transfer surface to the surface of the tissue mat.

EP-A-0 347 177 relates to a method of making soft tissue paper comprising the following steps: forming sheets from an aqueous suspension of cellulose fibers to form a mat, application of a sufficient amount of water-soluble non-cationic surfactant and drying and creping the mat, this tissue paper exhibiting a basis weight of 10 to 65 g/m² and a density of less than 0.6 g/m³. The teaching of this document is restricted to the addition of chemicals to wet fibre web.

The cited prior art documents thus involve adding treatment chemicals both in the wet section of a tissue paper machine (wadding machine), at the end of the screen section, before or inside the press section (mechanical drainage), i.e. in the case of solid contents between 20 and 50%, and in the dry section disposed after the press section in the case of solid contents of 40 to 97% fibrous dry weight.

The prior art is represented by feed sites on the transfer screen/belt, e.g. ahead of mat transfer in a TAD layout, and the supply to the moist fibrous mat after its transfer to the transport (dry) felt before the press or presses in a conventional single-felt or double-felt tissue machine.

The supply of treatment chemicals by spray application onto the yankee cylinder is also known in the prior art.

The addition of the treatment agent within the tissue making machine is brought about by spray application onto the pope roller to produce a film of treatment agent and subsequently to transfer it to the tissue web during rolling up. The already creped “tissue web” usually still exhibits a residual temperature of between 20° C. and about 70° C. as a result of the preceding drying process on the yankee cylinder, which benefits the distribution of treatment agent and its penetration of the raw tissue.

In addition to spray application via a nozzle bar, the use of centrifugal rotors or brush units is possible. Application may also be effected directly onto the tissue paper web.

Addition of the treatment agent, within a so-called doubling machine or within the processing machine, to the outer plies of the multiply doubled web before or during calibration/smoothing is generally preferred.

Application of the treatment agent to the outer plies of the web frequently takes place within the processing machine, the web being guided in multiply fashion by use of a plurality of unwindings in the processing machine or being previously doubled in multiply fashion.

WO 98/41687 describes a method of making tissue products of the aforementioned kind, this method being characterized by the fact that a composition of the above type is applied to the fibrous mat or tissue web within the screen section, press section, TAD section, on the yankee cylinder and/or dry section, i.e. at a fibrous material density of 20 to 97%, relative to the web's dry fibrous weight, in an amount of 0.1 to 40%, preferably 1 to 20%, continuously or discontinuously on or within the web and the web may undergo post-smoothing after application.

An alternative embodiment mentioned in this document relates to a method of making tissue products, this method being characterized by the fact that a composition of the above type is applied to the fibrous mat or tissue web after the dry section on the wadding machine, doubling machine and/or in the automatic processor in an amount of 0.1 to 40 wt. %, preferably 1 to 20 wt. %, continuously or discontinuously on or within the web and the web may undergo post-smoothing after application.

The known techniques suffer from various disadvantages that lead to an impairment of the tissue properties. The pressure exerted on the tissue, e.g. when using roller application techniques to apply the treatment agent, particularly during follow-up smoothing of the product treated with a treatment agent, causes the occurrence of undesirable mechanical effects upon the tissue. The tissue is compressed, thereby decreasing e.g. its thickness (bulk), which consumers usually feel to be detrimental e.g. in the case of a paper handkerchief. Such a subjective impression on the user's part in the example of a thickness that is perceived to be detrimental may in turn wreck any objective improvement e.g. in surface softness, because consumers refuse to buy such a product. This is a problem that is particularly faced by multiply tissue products.

Roller or spray-on application is limited by the viscosity of the lotion to be applied. Highly viscous and/or fatty lotions can be applied to paper by means of a spray technique only with extreme difficulty or not at all. It is therefore often necessary to use e.g. water or organic solvents to dilute or refine the treatment agent to be applied, entailing another process step in which the employed solvent has to be removed from the tissue once more.

The distribution of the treatment chemicals within the tissue over the surface of the paper web (sheet of paper) and the distribution in the z direction, i.e. perpendicular to the surface of the paper web optionally over all the plies of the tissue product, depends on various factors.

The composition of the treatment chemicals, particularly their viscosity and fat content here, play an important part in the depth of penetration.

The known application techniques such as spray application and the various roller application techniques entail only inadequate control of the distribution of treatment chemicals, particularly in the z direction, i.e. perpendicular to the surface of the tissue. This problem arises with particular clarity in multilayer tissue fabrics.

The treatment chemicals applied to the surface penetrate into the tissue only to a slight extent, and often remain only on the top-most layer. Only a smaller part passes to the inner region. This means a major disadvantage precisely in the case of tissue products that contain softness-enhancing treatment chemicals (sometimes also known as softness-promoting “lotions”) because these treatment agents are applied to the inner plies of the multiply tissue product only to an unsatisfactory degree. The desired effect of an improvement in bulk softness as a result of treating (applying lotion to) the tissue product can develop in this way only to an unsatisfactory degree.

On the other hand, the problem with tissue products that contain cosmetic treatment chemicals (sometimes also known as “cosmetic lotions”) is the even distribution of the cosmetic components of the treatment agent on the external surfaces of the treated tissue product's outer plies.

This is so because it is necessary, on the one hand, to apply a large amount of cosmetic components in order to ensure the desired action of the cosmetic substances upon transferral to the user's skin (healthcare) when using the tissue product, and to be able, for legal reasons, e.g. on grounds of competition law, to guarantee the evenness of the amount of treatment agent applied to the external surfaces of the tissue product's outer plies and on the other hand, for reasons of economy, to control within narrow limits the amount of such chemicals applied, because the cosmetic components of a lotion simultaneously represent very significant cost factors.

This problem of distributing the treatment chemicals that include e.g. emollients and/or cosmetic treatment chemicals plays an important part in the case of tissues.

For reasons of process economy, it is also desirable to reduce the number of application steps as far as possible. Roller or spray-on application is nevertheless limited by the viscosity of the lotion to be applied. Highly viscous and/or fatty lotions can be applied to paper by means of a spray technique only with extreme difficulty or not at all. It is therefore often necessary to use e.g. water or organic solvents to dilute or refine the treatment agent to be applied, entailing another process step in which the employed solvent has to be removed from the tissue once more.

If treatment chemicals that exhibit high viscosity or are solid at room temperature or exhibit low viscosity at room temperature are to be applied to the tissue in combination, it is frequently hard to find equipment and application conditions that enable even and systematic application for both components.

A similar problem may arise if there is a combination of hydrophobic (e.g. fatty) and hydrophilic components that tend to separate, which also makes even and systematic application difficult.

### OBJECT OF THE INVENTION

It is therefore an object of the present invention to make available a method that enables a controlled distribution of lotions in a fiber-based planar product, particularly tissue, in every dimension, the distribution being optimized for each particular use, in order to introduce specific treatment chemicals, if necessary in large amounts too, and to improve the properties of the tissue products, e.g. bulk softness.

According to one particular aspect, it is an object of the invention to make available an application method suitable for treatment compositions containing at least two treatment chemicals which in terms of application exhibit chemical and/or physical properties that are not very compatible with one another, e.g. hydrophobia/hydrophilicity or high/low viscosity at room or a solid/liquid state at room temperature.

Another object of the invention is to make available a correspondingly improved planar product, particularly tissue.

Lastly, a further object of the invention is to make available a device suitable for performing the application method.

The solution to these objects is described in the claims and will be explained in more detail below.

### DESCRIPTION OF THE INVENTION

The method according to the invention for applying a treatment composition containing at least one treatment chemical to a fiber-based planar product comprises the steps of:

a) applying the treatment composition to at least one side of the planar product, and

b) allowing the treatment composition to penetrate the tissue at least in part,

the treatment composition being heated before or during step b).

Heating the treatment composition causes a change in physical properties that play a part during application, e.g. viscosity or wetting characteristics, which makes suitable application possible.

Heating the treatment composition may for example be effected as follows:

(1) by heating the treatment composition before application to the planar product,

(2) by heating the planar product to which the treatment composition has previously been applied, or

(3) by applying the treatment composition to a pre-heated planar product.

It is also possible to combine techniques (1) and (2), (2) and (3), (1) and (3) or (1),(2) and (3).

Here, heating particularly means heating to temperatures above room temperature (e.g. more than 25° C.). Heating is preferably effected a maximum up to temperatures in which the components of the treatment composition start to decompose. The majority of treatment compositions used to treat tissue can thus easily be heated to temperatures of approx. 70-80° C. for a fairly short period. In individual cases, such as in the explosive evaporation of water described below, higher temperatures may, however, also be suitable.

The use of heating technique (1), optionally combined with technique (2) and/or (3), is particularly suitable for treatment compositions containing at least two treatment chemicals which, in terms of application, exhibit chemical and/or physical properties that are not very compatible with one another. Examples of such treatment chemicals are compounds exhibiting a high/low viscosity or hydrophilic/hydrophobic properties, e.g. fatty lotions and water. Heating prior to application of the treatment composition may, e.g. in the case of poorly miscible compounds, produce a homogeneous mixture as a result of exceeding the upper segregation point, which enables even application of the components. The use of an elevated temperature, optionally involving stirring, also causes two-phase mixtures to be converted into an e.g. emulsive state that enables even application.

The use of technique (2), i.e. heating the planar product to which the treatment composition had previously been applied, optionally in combination with technique (1) and/or (3), is preferably used in high-viscosity treatment compositions.

The treatment composition's application to the planar product is preferably effected by roll application and/or spraying, roll application techniques being more suitable for high-viscosity treatment compositions. The roll may have e.g. a structured surface for receiving and transferring the treatment composition, optionally in conjunction with devices such as a scraper, doctor blade (e.g. comb-type doctor blade) and a supply unit for the treatment composition. A suitable example of such a roll is a grid-type marking roll. Air rolls that have an air film over the roll are equally suitable. Such techniques are also suitable for applying another treatment composition.

If the intention is to promote the treatment composition's penetration into the planar product, particularly the tissue, and/or fixation thereof, preference is given to applying a subatmospheric pressure at that side of the planar product which was not treated with the treatment composition. In this way, the treatment composition is sucked into the planar product. This version of the method is particularly suitable if the aim is to distribute the treatment chemicals evenly within the product, especially the tissue (surface and interwoven fiber structure). The subatmospheric pressure is preferably produced by means of a suction shoe, suction roll or suction box.

In the case of treatment compositions that exhibit a high water content, heating technique (2) also makes systematic explosive evaporation of water possible. This may, depending on the composition's depth of penetration at the time of heating, reduce the density of the planar product, particularly tissue (bulk volume), and promote the product's (surface) softness (fluffiness). This effect may also be enhanced by application of a vacuum.

Depending on which temperature is chosen for the heating step, it may be an advantage to cool the planar product, particularly tissue, after application of the vacuum. This preferably comes about by supplying cold air or by means of a cooling unit, e.g. a cooled roll, located on the planar product, especially tissue. If there is just minimum heating, it is also possible to allow the planar product, particularly tissue, to cool down in the ambient air.

Depending on the properties aimed at for the planar product, particularly tissue, it may be beneficial to apply at least one other treatment composition to the product after application of vacuum. This is e.g. particularly advisable when individual treatment chemicals are sensitive to heat and thermal decomposition is to be avoided, or if the treatment chemicals are to be systematically applied to the surface of the tissue alone, e.g. in the case of skin care agents.

The fiber-based planar product, especially tissue, preferably moves relative to the site of application.

In a preferred embodiment of the method, the amount of treatment chemicals applied to the planar product, particularly tissue, and/or the water content of the tissue is measured after application of the vacuum. Particular. preference is given to using the measurement results to control the amount of treatment chemicals to be applied and/or to control the heating means. An infrared spectrometer is preferably used for the purpose of measurement, the near infrared spectrum being particularly suitable for measurement purposes. This feedback mechanism enables particularly accurate adjustment of the properties exhibited by the planar product, especially tissue.

The planar product, particularly tissue, and/or the treatment composition are preferably heated by a hot roll, hot air, infrared radiation, ultrasonics, and/or microwave radiation.

The treatment composition may comprise a single treatment chemical or a blend of at least two treatment chemicals. This treatment composition may also contain compounds that have no influence or only a slight influence on the properties of the treated planar product, particularly tissue, e.g. solvents (such as water and/or alcohol), auxiliary substances and/or additives. It may therefore be present e.g. as an aqueous solution or dispersion (e.g. suspension or emulsion) or comprise one or more treatment chemicals (water not included). Water may, however, also be an important active constituent of the treatment composition, particularly in cosmetic lotions intended to achieve a pleasant moist sensation on the skin. Water is then preferably used in combination with hygroscopic compounds such as the polyhydroxy compounds described below. Depending on the treatment composition's function, the proportion of optionally present solvents (including water) in the composition is preferably less than 60 wt. %, with greater preference on less than 30 wt. %, even greater preference on less than 10 wt. %, particularly less than 5 wt. %, each relative to the total weight of the composition.

The treatment chemical(s) may be selected from the following compound classes or compounds.

Agents for skin care and protection, so-called cosmetic lotions such as

moisturizers, such as substituents for the skin's natural moisturizing factor (NMF) that contain e.g. cleavage products of collagen, glycerol etc.;

skin care agents, e.g. long-chain fatty acid esters (like sorbitan fatty acid ester or Cetiol®), lanolin or derivatives thereof;

fragrances, e.g. natural, naturally identical or artificial perfumes; and/or

active cosmetic ingredients like D-panthenol or the active camomile ingredient α-bisabolol or agents exhibiting other functions, e.g.

strength-enhancing agents, particularly wet-strength agents like epichlorohydrin resins or crosslinked polyalkylene amines,

agents that promote the softness (e.g. bulk softness or surface softness) of the planar product, particularly the tissue; e.g. a polyhydroxy compound (e.g. ethylene glycol, propylene glycol, a liquid polyethylene glycol (derivative), a liquid polypropylene glycol (derivative) and/or glycerol), also quaternary ammonium compounds as described e.g. in U.S. Pat. No. 5,312,522 or 5,397,435 and the prior art cited therein, optionally in combination with the polyhydroxy compounds described in both these documents; or a poly(siloxane), particularly the (poly) siloxanes described in EP-A-347 153 and EP-A-347 154,

surfactants used e.g. as absorption rate control agents, e.g. long-chain quaternary ammonium compounds that may also exhibit softness-promoting action,

waxes, oils, and/or

inorganic or organic pigments or dyes.

A preferred basic composition for improving softness, especially bulk softness, comprises the following recipe:

| | |
|---|---|
| glycerol: | 40-45% |
| propylene glycol: | 28-30% |
| linden extract: | 2.5-3.5% |
| water | up to 100% |

The total amount of nonvolatile treatment chemical(s) applied in the treated surface area of the planar product, particularly tissue, is preferably 0.01 to S0 wt. %, with greater preference on 0.5-45 wt. % and even greater preference on 0.75-40 wt. %, relative to the weight of the untreated oven-dried planar product, particularly tissue (oven-dried being understood in accordance with German standard DIN EN 20638). Even greater preference is given to values of 1-35 wt. %, particularly 2-30 wt. % (what is considered to be volatile is any component that volatilizes upon further processing of the planar product, especially tissue, e.g. solvent such as water, unless it is intended to remain in the composition, e.g. a cosmetic lotion.).

The method according to the invention can also be used to coat both sides of a planar product, particularly a (one-ply or multiply) tissue (product). This may be effected using the same or different treatment compositions.

The device for applying a treatment composition to a fiber-based planar product, particularly tissue, comprises:

a) application means (1) for applying the treatment composition, such means being disposed on at least one side of the planar product, particularly tissue, and

b) means (3) for heating the planar product and/or treatment composition.

In a preferred embodiment, the device according to the invention comprises:

a) application means for applying the treatment composition, such means being disposed on at least one side of a planar product, particularly tissue, moving relative to the application means,

b) means for heating the planar product, such means being disposed behind the application means in relation to the direction of movement of the planar product, and

c) suction means disposed on that side of the planar product opposite the application means, and at the same height or behind the heating means in relation to the direction of movement of the planar product.

The device according to the invention may also comprise cooling means disposed behind the suction means in relation to the direction of movement of the planar product.

It may also be an advantage to provide the device with additional application means for applying at least one other treatment composition, such means being disposed behind the suction means in relation to the direction of movement of the planar product.

The device preferably comprises measuring and regulating means (actuator) for controlling the amount of treatment chemicals to be applied and/or the water content of the planar product, particularly tissue. The control mechanism is based e.g. on the measurement using an infrared spectrometer.

In a further preferred embodiment, the device according to the invention contains a supporting surface, e.g. an optionally moving supporting screen, for the web of planar product, particularly tissue web, this screen being arranged between the suction means and the planar product. The supporting surface, e.g. the supporting screen, stabilizes the movement of the planar product and optionally prevents the planar product from being too strongly attracted by the suction means and being damaged as a result.

The present invention also relates to a fiber-based planar product that contains a treatment composition; this product can be obtained according to a method that comprises the steps described above. The term “fiber-based planar product”, as used here, stands for planar products made of fibers (especially fibers that contain cellulose, such as pulp), for example nonwovens or tissues, with tissue representing a particularly preferred embodiment.

The term “tissue” as defined by the present invention is understood as any kind of creped paper made from an aqueous dispersion and having a basis weight range of usually between 10 and 65 g/m². In accordance with the invention, the term “tissue” covers both

the entire range of raw creped paper, also known as “raw tissue”, particularly the range of dry-creped raw tissue paper, regardless of whether they are single-layer or multilayer,

and any single-layer or multilayer end products made of this creped raw paper.

“Raw tissue” is usually made as a one-ply tissue web in the tissue (paper) machine or as an optionally multiply (intermediate) product, e.g. in the form of multiply doubled webs or in the form of master rolls for further processing. The term “layers” refers to a change in chemical and/or physical properties within a tissue ply; such a change may be caused e.g. by a different fiber composition. in contrast to plies, layers usually cannot be separated from one another.

The final product is preferably

a cleaning wipe, e.g. wiping paper, a windscreen cleaning wipe, a cleaning wipe for industrial applications, a towel or a cleaning wipe for household use, e.g. kitchen paper;

a sanitary product, e.g. toilet paper (also moist);

a paper handkerchief (also moist);

a household towel, e.g. kitchen towels;

a towel;

a tissue for facial use, e.g. a makeup removal tissue (facial) or cosmetic tissue,

a serviette/napkin,

bed linen;

a garment, e.g. disposable apparel for hospitals or kitchen staff.

Particularly preferred tissue products are handkerchiefs, tissues for facial use, sanitary products (e.g. toilet paper) and towels in which the application of cosmetic treatment compositions and/or treatment compositions that convey softness (lotions) plays a part.

The term tissue paper must also be regarded independently of the fibrous raw material to be used, particularly irrespective of whether the fibrous raw material is made solely or mainly from natural pulps e.g. according to the sulfate or sulfite process, or is used in a mixture with chemothermomechanical wood pulps (e.g. CTMP, or HTCMP), or whether the fibrous raw material used comes from a secondary fiber refinement process and whether the fibrous raw material needed to make tissue therefore completely or partially comprises “recycled fibers”.

To distinguish from nonwovens, it should be noted that although the predominant use of natural (cellulose-containing), i.e. vegetable, pulp fibers broken up in a manner suitable for paper making is typical of tissue paper manufacturing, a proportional use by refinement of modified pulp fibers in a range of 10 to 50 wt. %, relative to the total weight of the fibers, or even a use of synthetic fibers suitable for paper making in an amount of 10 to 30% are covered by the aforementioned definition of the term “tissue”. It is analogously possible to apply the method beyond the field of paper making to corresponding fields in the nonwoven and textile sectors.

Upon application of the treatment composition, it is possible to start out e.g. from a multiply, usually two-ply to four-ply or multiply (doubled) master roll produced in a separate doubling machine. A plurality of one-ply tissue webs can alternatively be treated (one unwinding each) and then jointly rolled up into a multiply tissue product via a roll-up device. This produces the advantage that e.g. the inner plies can be treated with a treatment chemical other than that for the outer plies. For example, the inner plies of a four-ply end product can remain untreated, or can be treated with a strength-enhancing agent, whereas the two outer plies were treated with a treatment chemical to improve surface softness. In principle, an extremely wide variety of combinations of differently treated tissue plies is conceivable.

In one embodiment, the tissue is a four-ply or three-ply doubled raw tissue for making handkerchiefs or facials, the tissue being made available in the form of master rolls for the application of a treatment agent in a processing machine suitable for this purpose. The processing machine comprises at least one unwinding device for the master rolls, a roll-up device for the product finished after application of a treatment agent, and an interposed applicator for applying the treatment agent.

The method according to the invention will now be explained in more detail by means of a Figure.

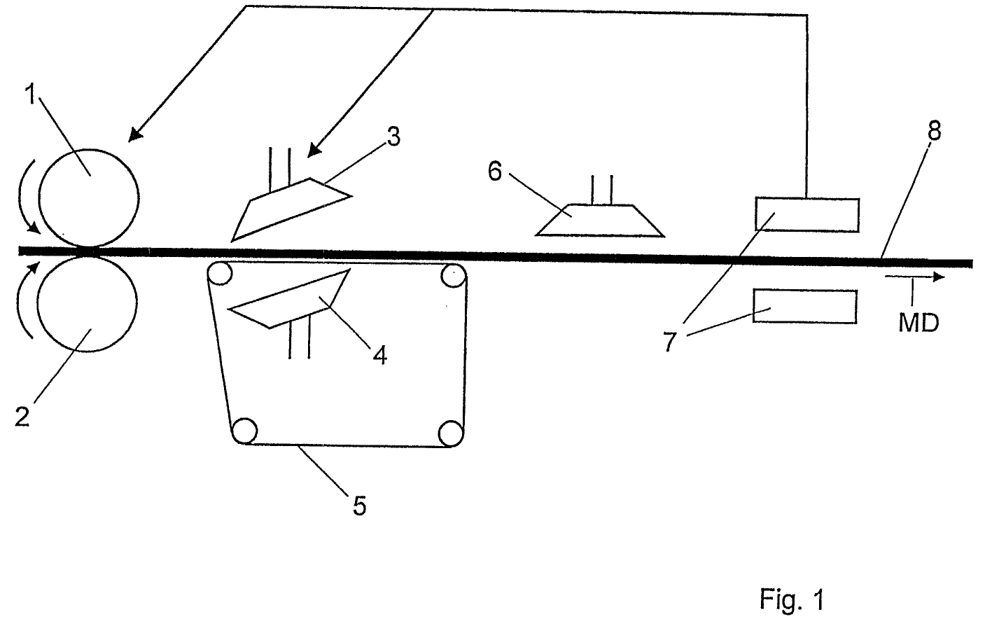

FIG. 1 is a diagrammatic illustration of a preferred embodiment of the application method and device according to the invention in which the reference numbers have the following meanings:

(1) first roll (application roll)

(2) backing roll

(3) heating means

(4) suction means (suction shoe, suction box, suction roll)

(5) supporting screen

(6) cooling means (supply of cold air)

(7) measuring and control unit

(8) tissue web (after application)

(MD) machine direction

In FIG. 1 the treatment chemicals (not shown) are applied by the first roll (1) to the upper side of the tissue. The backing roll (2) serves to stabilize the tissue web. The tissue web with the thus applied layer of treatment chemicals is heated by the heating means (3), e.g. infrared radiation and/or hot air, from the upper side and at the same time is subjected to a subatmospheric pressure from the lower side, this subatmospheric pressure drawing the heated treatment chemicals into the tissue. A revolving endless screen (5) supports the tissue web. The measuring and control unit (7) measures e.g. the tissue web's water content and/or the content of specific treatment chemicals and regulates the heating means (3) and/or the amount applied at the roll (1).

To explain the present invention, reference is also made to the introductory portion of the specification where e.g. general properties of tissues and methods for their production are described.

1. A method of applying a treatment composition containing at least one treatment chemical to a dry and creped tissue, said method comprising the steps of:
a) applying the treatment composition to one side of the dry and creped tissue, and
b) heating the applied treatment composition and/or the dry and creped tissue, to which the treatment composition has been applied, in order to allow the treatment composition to penetrate the dry and creped tissue at least in part.

2. A method of applying a treatment composition according to claim 1, wherein the penetration of the treatment composition is promoted by applying a subatmospheric pressure at that side of the dry and creped tissue not treated with the treatment composition.

3. A method according to claim 1 or 2, wherein heating the treatment composition is effected by heating the dry and creped tissue to which the treatment composition has been previously applied.

4. A method according to any of the preceding claims, involving one additional heating step wherein the treatment composition is also heated before the application to the dry and creped tissue.

5. A method according to any of the preceding claims, wherein the application of the treatment composition to the dry and creped tissue is effected by roll application and/or spraying.

6. A method according to any of the preceding claims, wherein the dry and creped tissue is heated by a hot roll, hot air, infrared radiation, ultrasonics, and/or microwave radiation.

7. A method according to any of the preceding claims, particularly according to claim 4, wherein the treatment composition contains at least two treatment chemicals.

8. A method according to claim 7, wherein at least one treatment chemical is hydrophilic and at least one treatment chemical is hydrophobic.

9. A method according to claim 7, wherein at least one treatment chemical exhibits high viscosity and at least one treatment chemical exhibits low viscosity.

10. A method according to any of claims 2 to 9, wherein the subatmospheric pressure is produced by a suction shoe, suction roll or suction box.

11. A method according to claims 2 to 10, wherein the dry and creped tissue is cooled after application of a subatmospheric pressure.

12. A method according to claim 11, wherein the tissue is cooled by cold air or a cooling unit.

13. A method according to any of claims 1 to 12, wherein at least one further treatment composition is applied to the dry and creped tissue after application of the first treatment composition and optionally further procedural steps.

14. A method according to any of claims 1 to 13, wherein the dry and creped tissue moves relative to the site of application.

15. A method according to claim 14, wherein the applied amount of treatment chemicals and/or the tissue's water content are measured after application of the vacuum (after passing through the suction means).

16. A method according to claim 14 or 15, wherein the measuring results are used to control the amount of treatment composition to be applied and/or to control heating.

17. A method according to claim 16, wherein the measurement is taken in near infrared.

18. A method according to at least one of claims 1 to 17, wherein the treatment chemicals comprise at least one of the following constituents:
strength-enhancing agents, emollients, surfactants, (in)organic pigments or dyes, oils, wax, and/or cosmetic lotions.

19. A method according to claim 18, wherein the cosmetic lotions comprise at least one of the following constituents: moisturizers, skin care agents, fragrances and/or active cosmetic ingredients.

20. A method according to claim 19, wherein the amount of treatment chemicals (solids content) is 0.01 to 50 wt. % relative to the untreated dry and creped tissue (oven-dried in accordance with German standard DIN EN 20638).
